(19) United States
(12) Patent Application Publication
(10) Pub. No.: US 2003/0147699 A1
(43) Pub. Date: Aug. 7, 2003

(54) System and apparatus for module insertion during pipeline installation

(76) Inventors: Wayne R. Long, Eagan, MN (US); Alvin J. Niebur, Hastings, MN (US)

Correspondence Address: Stuart R. Hemphill, DORSEY & WHITNEY LLP, Intellectual Property Department, 50 South Sixth Street, Suite 1500, Minneapolis, MN, 55402-1498, US

(21) Appl. No.: 10/354,420

(22) Filed: Jan. 30, 2003

Related U.S. Application Data
(60) Provisional application No. 60/354,120, filed on Feb. 4, 2002.

(51) Int. Cl. F16L 1/00; F16L 1/028; F16L 1/12

(52) U.S. Cl. 405/158; 405/168.1; 405/168.3

(57) ABSTRACT

A system and a method for introducing a module into a pipeline during deepwater pipeline installation wherein a hang-off clamp supports a pipeline and translates from a pipeline feeding position to a module connection position wherein a module is connected to the pipeline. By-pass lines support the pipeline and module and lower them past the hang-off clamp. The hang-off clamp resumes support of the pipeline and returns to the pipeline feeding position with the pipeline and module.

### PRIORITY

The present application claims the priority of U.S. provisional patent application No. 60/354,120 filed Feb. 4, 2002.

### FIELD OF THE INVENTION

The subject invention relates to pipeline installation equipment in bodies of water. More specifically, the subject invention relates to an apparatus and method for inserting in-line modules during pipeline installation.

### BACKGROUND OF THE INVENTION

Deepwater pipeline installation has forced the industry to move from the traditional S-lay style system for laying pipe to the relatively new J-lay style. Both types of systems can use the “stalk on” method of pipeline construction where sectional pipe is splice welded while in position on the S-lay ramp or on the J-lay tower. These systems can also utilize the “pipe storage reel” method of pipeline construction where the pipe is manufactured in continuous lengths on board the pipe-lay vessel or at a shore facility and then spooled onto a large transportation spool. The pipe is then un-spooled from the transportation spool, straightened and passed over the S-lay ramp or the J-lay tower.

In all pipelines there is a need to install large modules (special objects) on the ends and at intermediate locations along the pipeline. These modules are usually quite large and heavy and require interrupting the laying of the pipeline. Examples of such modules are initiation fittings and termination, branch, and inline manifolds. Because the stalk on method of pipeline construction utilizes sectional pipe, modules can be inserted relatively easily and with little additional interruption in operation when using this method. However, when using the pipe storage reel method, the continuous pre-manufactured pipe must be cut to allow for insertion of the module. This increases the time of interruption of operation and the potential for pipeline damage or loss as compared to the stalk on method.

When inserting modules into a J-lay pipe laying system that is utilizing the pipe storage reel method, the existing technology requires the use of two pipeline hang-off clamps and a relatively large crane. The typical steps for the existing technology using a J-lay pipe laying system employing the pipe storage reel method are as follows:

1. Support the continuous pipeline by the stationary hang-off clamp mounted on the J-lay tower (first hang-off clamp);

2. Sever the continuous pipeline above the first hang-off clamp, resulting in the continuous pipeline becoming two pieces, the suspended pipeline, which is the lower piece and still supported by the first hang-off clamp, and the stored pipeline, which is the upper piece and is fed from the pipe storage reel;

3. Weld a lifting head to the top end of the suspended pipeline and connect the boom hook/clasp of a large crane to the lifting head;

4. Using the large crane, apply tension to the lifting head and release the first hang-off clamp;

5. Using the large crane, lift the suspended pipeline from the first hang-off clamp and move the suspended pipeline into a remote located stationary hang-off clamp (second hang-off clamp);

6. Support the suspended pipeline with the second hang-off clamp;

7. Remove the large crane's boom hook/clasp from the lifting head and cut the lifting head from the top of the suspended pipeline and weld the module to the top of the suspended pipeline;

8. Weld a lifting head to the stem top of the module and connect the boom hook/clasp of the large crane to the lifting head;

9. Using the large crane, apply tension to the lifting head and release the second hang-off clamp;

10. Using the large crane, lift the module and attached suspended pipeline and move the combination back to the first hang-off clamp, simultaneously lowering the combination so that the module is below the first hang-off clamp;

11. Support the module and attached suspended pipeline by using the first hang-off clamp to clamp the stem top of the module;

12. Disconnect the crane and cut the lifting head from the stem top of the module;

13. Weld the end of the stored pipeline to the stem top of the module, effectively rejoining the suspended pipeline to the stored pipeline to form one continuous pipeline with an inserted module;

14. Transfer the pipeline weight from the first hang-off clamp to the pipe tensioners by taking in on the pipe tensioners; and

15. Resume laying pipe.

As is evident from the above steps, insertion of modules in J-lay systems utilizing the pipe storage reel method is an equipment and labor intensive process that results in significant interruptions in the pipe laying operations and increased risk of pipeline damage or loss. Specifically, the existing technology requires two hang-off clamps, a crane, many welding and cutting steps and many transfers of the pipeline between different pieces of support equipment.

Each transfer of the pipeline between support equipment increases the chance that the support equipment will fail to retain the pipeline, resulting in the pipeline slipping into the water and being lost. Consequently, there is a great need in the art for a system that will reduce the risk and the equipment, labor and time demands currently associated with inserting modules in J-lay systems utilizing the pipe storage reel method.

### BRIEF SUMMARY OF THE INVENTION

The subject invention, in one embodiment, is a system for introducing an in-line module into a pipeline during deepwater pipeline installation. The system has a tower for feeding the pipeline into the water and a hang-off clamp for suspending the portion of the pipeline that is in the water. The hang-off clamp is capable of translating horizontally with the pipeline from a pipeline feeding position to a module connection position. A means is provided for lowering the pipeline and connected module past the hang-off clamp so that the top of the module is below the bottom of the hang-off clamp.

Another embodiment of the subject invention is a method for introducing an in-line module into a pipeline during deepwater pipeline installation utilizing a tower for feeding the pipeline into the water. The pipeline is supported from a moveable hang-off clamp at a pipeline feeding position. The hang-off clamp then translates from the pipeline feeding position to the module connection position. A module is connected to the supported pipeline. The by-pass lines take the pipeline load from the hang-off clamp and the hang-off clamp translates to a position clear of the module connection position. The by-pass lines lower the pipeline and connected module to a position where the module top is below the hang-off clamp bottom. The hang-off clamp takes the pipeline load from the by-pass lines and translates with the pipeline and connected module back to the pipeline feeding position.

While multiple embodiments are disclosed, still other embodiments of the subject invention will become apparent to those skilled in the art from the following detailed description. As will be apparent, the invention is capable of modifications in various obvious aspects, all without departing from the spirit and scope of the subject invention. Accordingly, the drawings and detailed description are to be regarded as illustrative in nature and not restrictive.

### BRIEF DESCRIPTION OF THE DRAWINGS

FIG. 1 is a side elevation view of the stern portion of a pipeline laying ship with a continuous pipeline feeding from a pipe storage reel down through a J-lay tower.

FIG. 2 is an end elevation view of the stem portion of the pipeline laying ship with a continuous pipeline feeding down through the J-lay tower and supported by a hang-off clamp, the hang-off clamp being in the pipeline feeding position, and the continuous pipeline being ready to be severed.

FIG. 3 is the same view as FIG. 2 except the pipeline has been severed and has been horizontally translated by the hang-off clamp to a location beneath a module to be inserted, the hang-off clamp now being in the module connection position.

FIG. 4 is the same view as FIG. 3 except the pipeline has been welded to the module, the hang-off clamp has disengaged from the pipeline and horizontally translated away from the pipeline to the by-pass position, and the module has been lowered by the abandonment and recovery lines to a by-pass point below the hang-off clamp.

FIG. 5 is the same view as FIG. 4 except the hang-off clamp has translated horizontally back to the module connection position to engage and support the pipeline.

FIG. 6 is the same view as FIG. 5 except the hang-off clamp has horizontally translated the pipeline back to the pipeline feeding position and the pipeline is now welded to the top of the module to reform the continuous pipeline.

### DETAILED DESCRIPTION

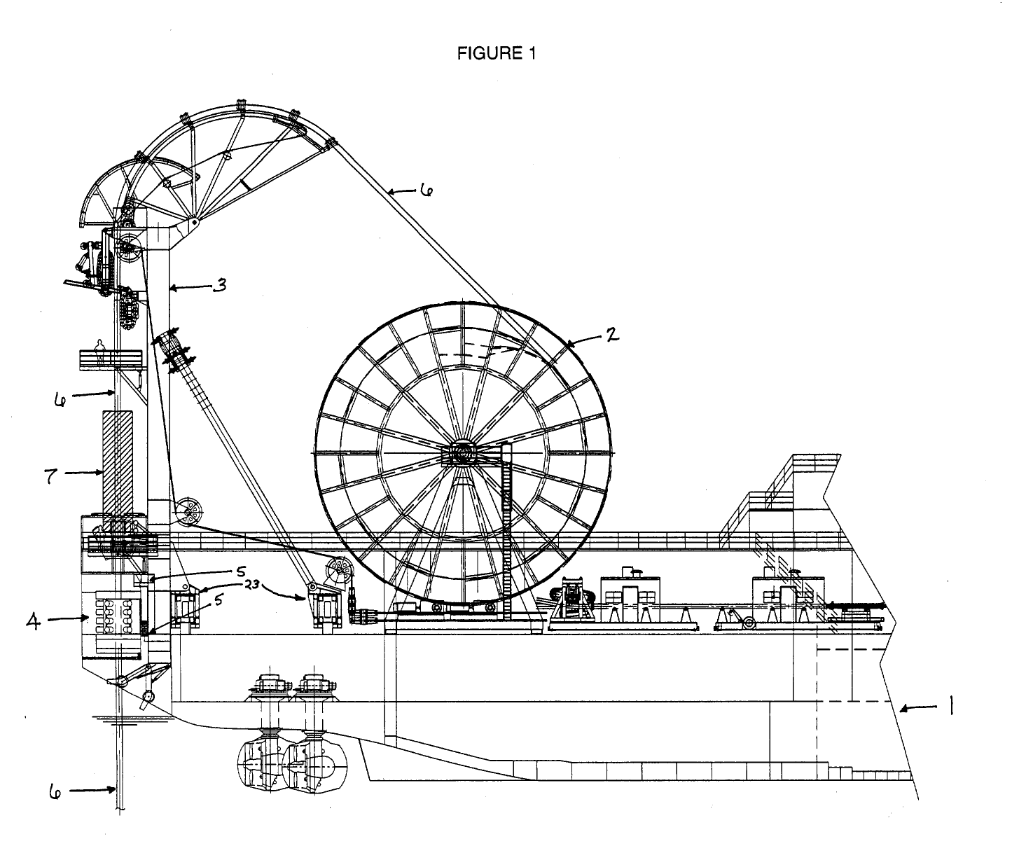

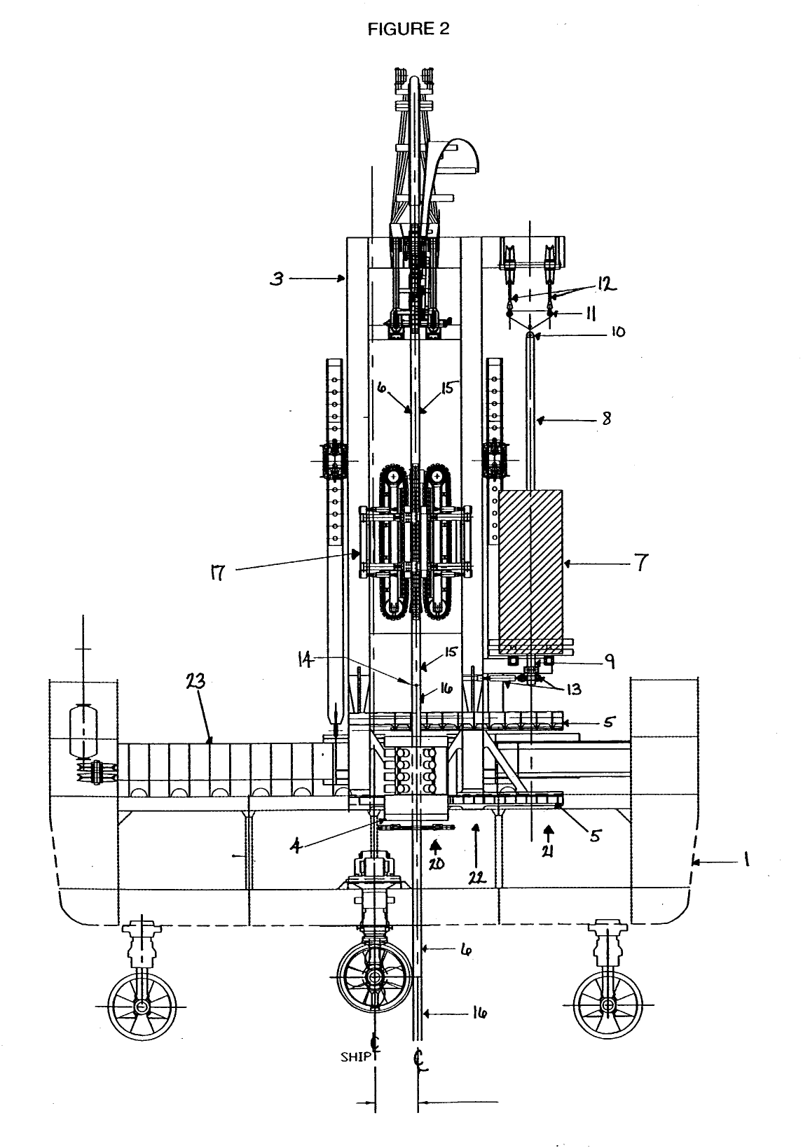

FIG. 1 shows a side elevation view of a pipeline laying ship's stem section 1. The stem 1 supports a pipe storage reel 2 and a J-lay tower 3 generally of the conventional type. A hang-off clamp 4 is supported for movement, in one embodiment, on rails 5. The hang-off clamp 4 is capable of moving horizontally along the rails 5. The rails 5 are attached to the J-lay tower 3. The J-lay tower 3 may also be mounted for movement on larger rails 23 (see FIG. 2) that are mounted on the stem 1. The J-lay tower 3 is capable of moving laterally along the larger rails 23. A continuous pipeline 6 may be fed from the pipe storage reel 2 up to and down through the J-lay tower 3 and down through hang-off clamp 4. FIG. 1 also shows a module 7 that may be inserted into the continuous pipeline 6, as will be explained later in this specification.

FIG. 2 shows an end elevation of the ship's stem 1. From this figure, one can see that the continuous pipeline 6 is being fed down through the J-lay tower 3, the pipe tensioners 17, and through the hang-off clamp 4. In this figure, the rails 5, on which the hang-off clamp 4 is moveably mounted, become more apparent. The hang-off clamp 4 is capable of translating horizontally along the rails 5. In one embodiment, the hang-off clamp 4 travels along the rails 5 on grooved wheels. For an example of single and double flanged grooved wheels, see U.S. Pat. No. 4,065,006 to Barry, issued Dec. 27, 1977. In another embodiment, a spur-gear and gear rack combination is utilized where the rails 5 have gear teeth and the hang-off clamp 4 travels along the rails 5 on geared wheels. For examples of spur-gears or pinion gears in combination with gear racks, see U.S. Pat. No. 4,397,199 to Jahn, issued Aug. 9, 1983, and U.S. Pat. No. 4,704,913 to Zimmer, issued Nov. 10, 1987. In yet another embodiment, the hang-off clamp 4 slides along the rails 5 on low-friction pads. For examples of pads or follower members sliding on rails, see U.S. Pat. No. 4,116,251 to Graney, issued Sep. 26, 1978, and PCT Application WO 01/53131 A1 by Mink et al., published Jul. 26, 2001. Persons skilled in the art will readily recognize other means of supporting the hang-off clamp 4 on the J-lay tower 3 as the hang-off clamp 4 translates horizontally. Consequently, these embodiments are provided as examples and are not meant to limit the invention.

Those skilled in the art will recognize that the entire length of the rails 5 and their accompanying support from the J-lay tower 3 will need to be capable of supporting the pipeline-laying loads encountered by the hang-off clamp 4. The means and methods of supporting the loads on the rails 5 and the J-lay tower 3 are varied and well known in the art. This specification hereby incorporates those well-known means and methods of supporting loads.

Means for moving the hang-off clamp 4 along the rails include prime movers for spur-gear and gear rack combinations, hydraulic rams, cable and pulley combinations, worm-screw jack configurations or similar means for transferring force mechanically. Persons skilled in the art will readily recognize other means of moving the hang-off clamp 4 horizontally along the rails 5. Thus, these embodiments are provided as examples and are not meant to limit the invention.

In FIG. 2, the details of the module 7 become more apparent. The module 7 has an upper stem 8 and a lower stem 9 that are pre-welded to the module 7. The upper stem 8 has a lifting head 10 welded to the top end of the upper stem 8. The lifting head 10 is attached to the clasp 11 of the abandonment and recovery lines (A/R lines) 12. The A/R lines 12 are cables that are extended and retracted by a winch (not shown in any figure) and are common to pipeline laying ships. The A/R lines 12 suspend the module 7 until the hang-off clamp 4 can support the module 7. As explained later, the A/R lines 12 also play a role in permitting the module 7 to by-pass the hang-off clamp 4. Thus, the A/R lines 12 or other means for lifting and lowering in the same manner, such as a crane, may be called by-pass lines.

One end of a stem-clasping arm 13 is attached to the J-lay tower 3 while the other end of the stem clasping arm 13 clasps the lower stem 9 of the module 7. Thus, the module 7 is rigidly held in place by the stem clasping arm 13 and the clasp 11 of the A/R lines 12.

Those skilled in the art will note that, in one embodiment of the subject invention, the subject invention does not have a large crane or a second remotely located hang-off clamp as are utilized in the existing technology. This is because the subject invention makes the large crane and the second remotely located hang-off clamp unnecessary for module insertion in J-lay systems using the pipe storage reel method. Thus, the subject invention is advantageous over the existing technology in that the subject invention requires less auxiliary equipment. More advantages will be come apparent later in this specification, including the fact that the subject invention requires fewer welding and cutting operations and fewer transfers of the pipeline between equipment, as compared to the existing technology.

The method for utilizing the new invention will now be narrated. FIG. 2 illustrates the locations of the various pieces of equipment when the continuous pipeline 6 is in a process of being fed down through the J-lay tower 3, the pipe tensioners 17, and the hang-off clamp 4. The module 7, which is awaiting its insertion into the continuous pipeline 6, is rigidly held in place by the clasp 11 of the A/R lines 12 and the stem-clasping arm 13. The A/R lines 12 are in their retracted position. The position of the hang-off clamp 4, as reflected in FIG. 2, when the vertical axes of the hang-off clamp 4, the continuous pipeline 6, the pipe tensioners 17, and the J-lay tower 3 all substantially coincide, will be termed the pipeline feeding position or station 20.

The pipeline laying operation may reach a point on the continuous pipeline 6 where a module 7 will be inserted. The pipe storage reel 2, shown in FIG. 1, stops feeding the continuous pipeline 6 down through the J-lay tower 3, the pipe tensioners 17, and the hang-off clamp 4. Referring again to FIG. 2, the hang-off clamp 4 securely grips the continuous pipeline 6 to support the continuous pipeline 6. The continuous pipeline 6 is severed at the cutting location 14. The continuous pipeline 6 is now in two pieces. The upper piece is called the stored pipeline 15 and runs from the cutting location 14 up through the pipe tensioners 17 and the J-lay tower 3 to the pipe storage reel 2 (shown in FIG. 1). The lower piece is called the suspended pipeline 16 and runs from the cutting location 14 down through the hang-off clamp 4. The hang-off clamp 4 supports the suspended pipeline 16 and prevents the suspended pipeline 16 from dropping into the water and becoming lost. The suspended pipeline 16 and its supporting hang-off clamp 4 are now in position for horizontal translation along the rails 5 from the pipeline feeding position 20 to a location below the module 7.

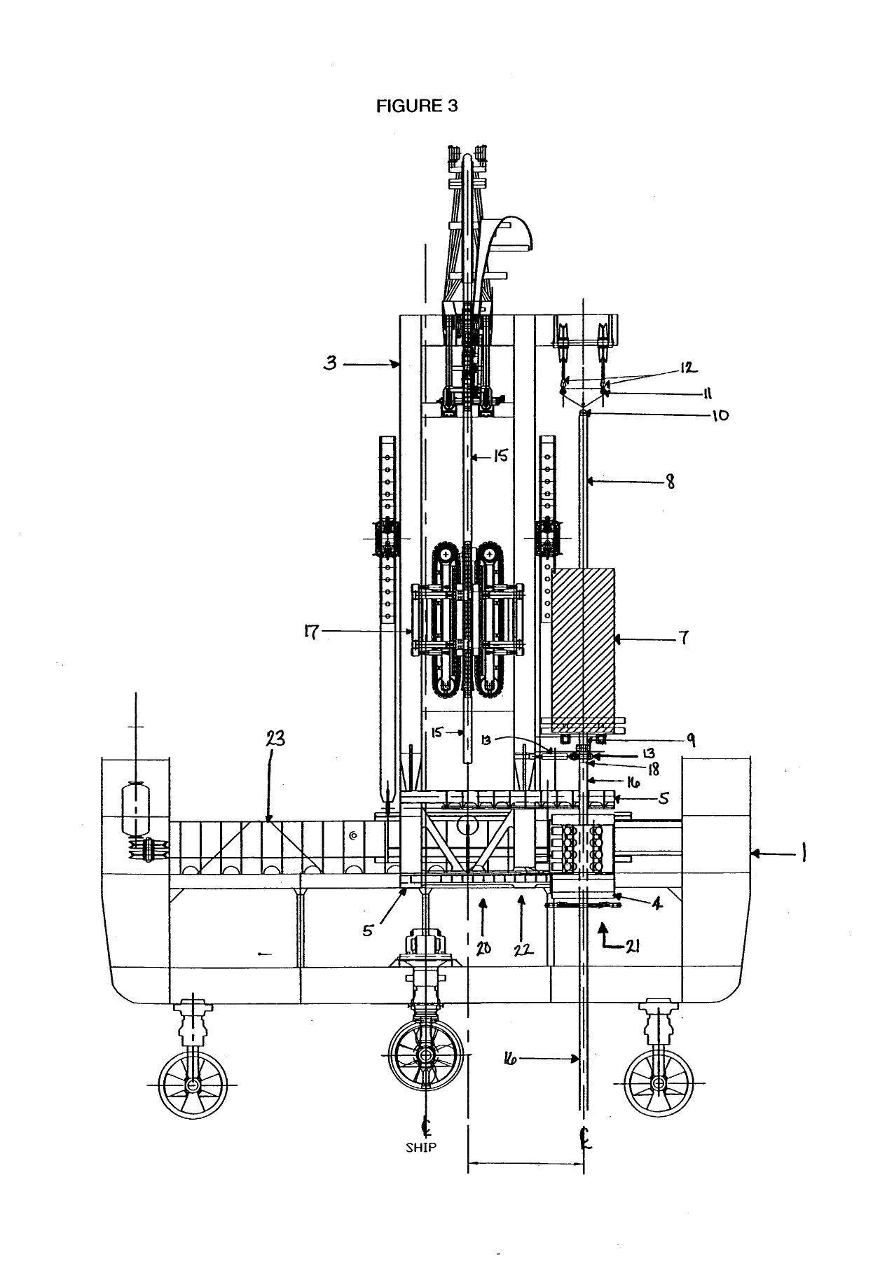

FIG. 3 illustrates the suspended pipeline 16 and its supporting hang-off clamp 4 after they have traveled horizontally along the rails 5 from the pipeline feeding position 20 illustrated in FIG. 2 to a location below the module 7. The position of the hang-off clamp 4, as reflected in FIG. 3, when the vertical axes of the suspended pipeline 16, the hang-off clamp 4, the upper stem 8, the lower stem 9, and the module 7 all substantially coincide, will be termed the module connection position or insertion station 21.

Once the hang-off clamp 4 is in the module connection position 21, as illustrated in FIG. 3, the free ends of the suspended pipeline 16 and the lower stem 9 are aligned and welded together to form a welded joint 18. The joined combination of the suspended pipeline 16 and the module 7 is now in condition to be supported solely by the lifting head 10, which is suspended from the clasp 11 of the A/R lines 12. The A/R lines 12 are still in their retracted position and are taken up as needed to take over the load. The hang-off clamp 4 then releases the suspended pipeline 16, the load of the suspended pipeline 16 and the module 7 now being entirely supported by the A/R lines 12. At this point, those skilled in the art will recognize that the functions performed by the A/R lines 12 may be performed by a wide variety of well known lifting and transferring devices, including cranes. Thus, the subject invention should not be limited only to utilization of the A/R lines 12 but should be interpreted to include any lifting and transferring device that is capable of carrying and lowering the pipeline-laying loads encountered by the hang-off clamp 4 of the subject invention.

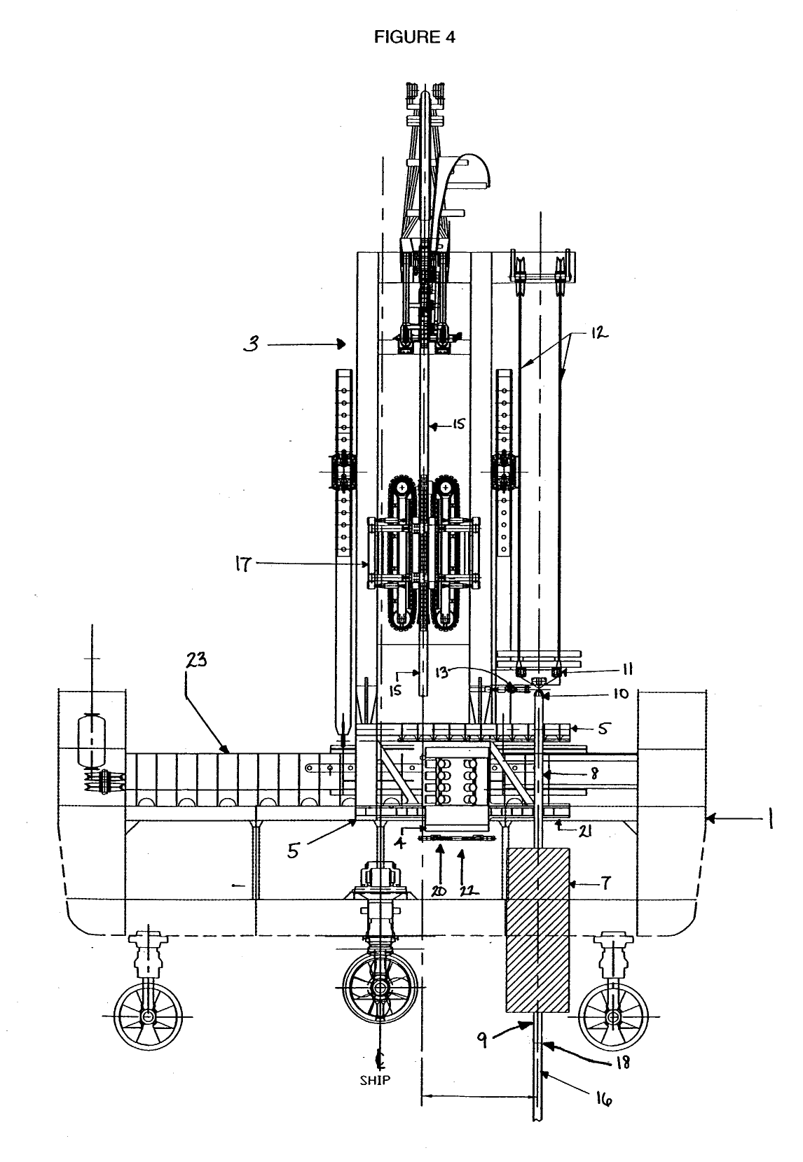

As the A/R lines 12 support the suspended pipeline 16 and the module 7, the stem-clasping arm 13 arrests their horizontal movement. The hang-off clamp 4 is now in condition for horizontal translation away from the module connection position 21 to a location approximately midway between the module connection position 21 and the pipeline feeding position 20. This new position for the hang-off clamp 4 may be called the by-pass position or station 22 and is reflected in FIG. 4. It should be noted that while FIG. 4 illustrates the by-pass position 22 as being approximately midway between the pipeline feeding position 20 and the module connection position 21, the by-pass position 22 could be any location along the rails 5 on either side of the module connection position 21, including the pipeline feeding position 20, that would provide sufficient clearance for the module 7 to clear the hang-off clamp 4 as the module 7 is lowered.

The combination of the suspended pipeline 16 and the module 7 is now in position to be lowered by the A/R lines 12 to a position where the top of the module 7 will be located below the bottom of the hang-off clamp 4. The A/R lines 12 serve as a by-pass system in that they allow the combination of the suspended pipeline 16 and the module 7 to by-pass the hang-off clamp 4. As previously stated, persons skilled in the art will recognize that other well known lifting and lowering mechanisms may be used as a by-pass system. Therefore, the subject invention should not be limited to only A/R lines 12 as the by-pass system, but should be interpreted as incorporating those other well known lifting and lowering mechanisms, including cranes. The order of events is as follows. First, the A/R lines place tension on the lifting head 10 to allow for release of the hang-off clamp 4. The hang-off clamp 4 then releases the suspended pipeline 16 and horizontally translates from the module connection position 21 to the by-pass position 22 thereby providing clearance for the module 7 to pass by the hang-off clamp 4. Next, the stem clasp arm 13 disengages from the lower stem 9 and retracts away from the path of the module 7. Finally, the A/R lines 12 begin lowering the combination of the suspended pipeline 16 and the module 7 to a position where the top of the module 7 is located below the bottom of the hang-off clamp 4. The hang-off clamp 4 and the module 7 are now in the positions reflected in FIG. 4. The A/R lines 12, as reflected in FIG. 4, are now in their extended position.

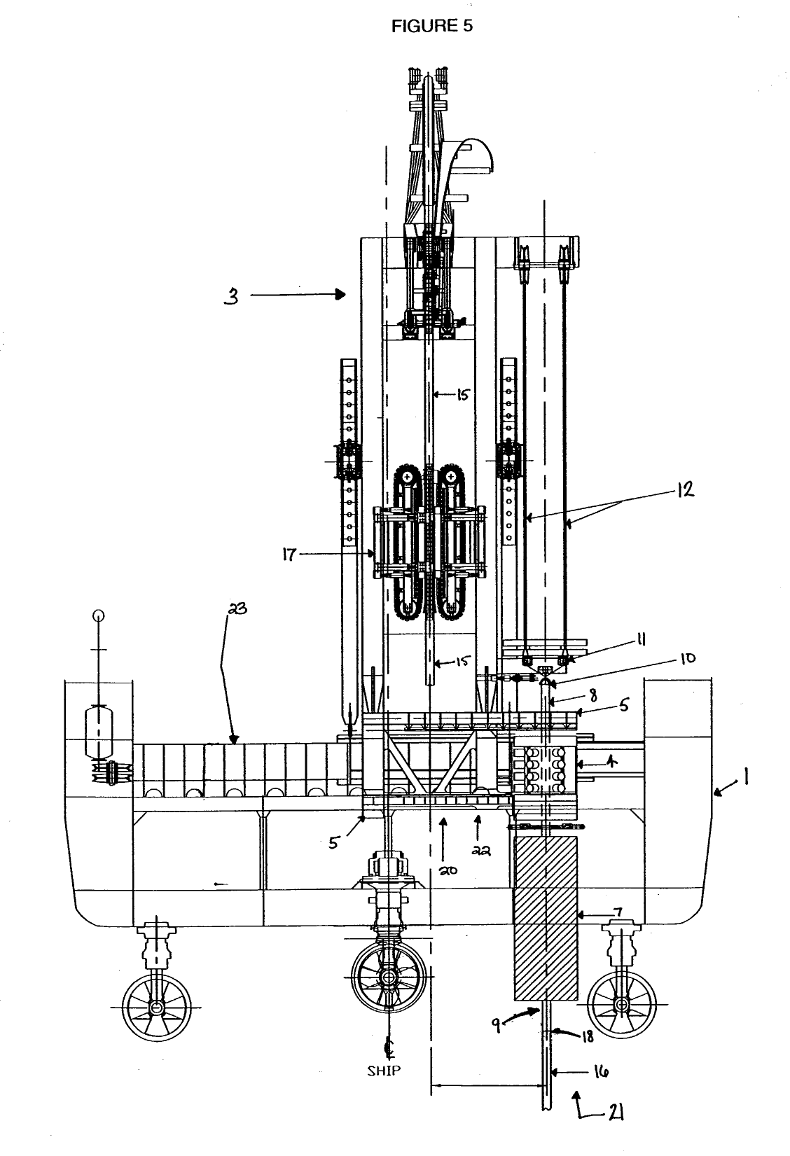

The hang-off clamp 4 now horizontally translates from the by-pass position 22, as reflected in FIG. 4, back to the module connection position 21, as reflected in FIG. 5. Once back in the module connection position 21, the hang-off clamp 4 grips the upper stem 8 thereby becoming capable of supporting the combination of the suspended pipeline 16 and the module 7. The hang-off clamp 4, the module 7, and the A/R lines are now in the positions reflected in FIG. 5.

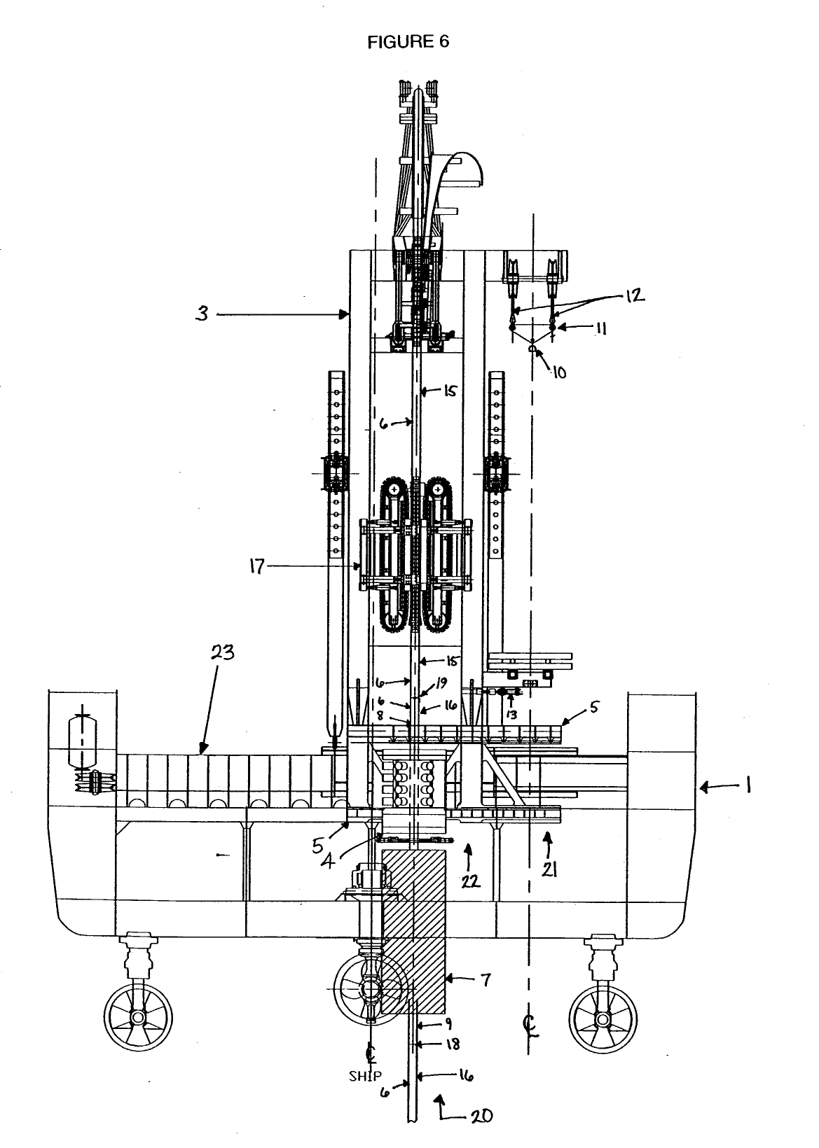

The A/R lines 12 then release the combined load of the suspended pipeline 16 and module 7 to the hang-off clamp 4. The clasp 11 is disengaged from the lifting head 10 and the A/R lines 12 are retracted. The lifting head 10 is then cut off of the top of the upper stem 8. The hang-off clamp 4, supporting the combination of the suspended pipeline 16 and the module 7, then horizontally translates from the module connection position 21, illustrated in FIG. 5, to the pipeline feeding position 20, illustrated in FIG. 6. Once the hang-off clamp is back in the pipeline feeding position 20, the ends of the upper stem 8 and the stored pipeline 15 are welded together, forming a second welded joint 19. At this point, the stored pipeline 15, the upper stem 8, the lower stem 9, the module 7 and the suspended pipeline 16 form a continuous pipeline 6 having an inserted module 7.

The continuous pipeline 6, the module 7 and the hang-off clamp 4 are now in the positions reflected in FIG. 6. The pipe tensioners 17 then prepare to take over the support of the continuous pipeline 6 from the hang-off clamp 4 by applying tension to the continuous pipeline 6. Once the load of the continuous pipeline 6 has been transferred to the pipe tensioners 17, the hang-off clamp 4 releases the continuous pipeline 6 and the pipe storage reel 2 begins to feed the continuous pipeline 6 down through the J-lay tower 3, the pipe tensioners 17 and the hang-off clamp 4 as pipeline laying operations resume.

Persons skilled in the art will realize that the subject invention is advantageous over the existing technology. For example, one advantage of the subject invention is that it requires fewer transfers of the pipeline between supporting equipment, as compared to the existing technology. Each transfer of the pipeline between supporting equipment presents the risk that the supporting equipment will fail to retain the pipeline thereby allowing the pipeline to drop into the water and become lost.

In the existing technology there are six transfers of the pipeline between support equipment. These transfers are as follows:

1. transfer the pipeline from the pipe tensioners to the stationary hang-off clamp supported by the J-lay tower (first hang-off clamp);

2. transfer the pipeline from the first hang-off clamp to the crane hook/clasp;

3. transfer the pipeline from the crane hook/clasp to the remote located stationary hang-off clamp (second hang-off clamp);

4. transfer the pipeline with the connected module from the second hang-off clamp to the crane hook/clasp;

5. transfer the pipeline with the connected module from the crane hook/clasp to the first hang-off clamp; and

6. transfer the pipeline with the connected module from the first hang-off clamp to the pipe tensioners.

In one of the subject invention's embodiments, there are four transfers of the pipeline between support equipment. These transfers are as follows:

1. transfer the pipeline from the pipe tensioners to the translating hang-off clamp;

2. transfer the pipeline with the connected module from the translating hang-off clamp to the clasp of the A/R lines;

3. transfer the pipeline with the connected module from the clasp of the A/R lines to the translating hang-off clamp; and

4. transfer the pipeline with the connected module from the translating hang-off clamp to the pipe tensioners.

Thus, it is clear that the subject invention is advantageous over the existing technology because it involves fewer transfers of the pipeline between equipment and thereby reduces the opportunity for the pipeline to be dropped and lost.

Another advantage of the subject invention over the existing technology is that one of the subject invention's embodiments requires one less welding operation and one less cutting operation. Specifically, the existing technology's step of welding a lifting cap onto the pipeline prior to transferring the pipeline with the crane from the first hang-off clamp to the second hang-off clamp is not required with one of the subject invention's embodiments. Also, the cutting off of the same lifting cap prior to the attachment of the module is not required in one of the subject invention's embodiments.

Another advantage of the subject invention over the existing technology is that one of the subject invention's embodiments requires less equipment. Specifically, it does not require the large crane and second hang-off clamp that are required by the existing technology.

Although the subject invention has been described with reference to preferred embodiments, persons skilled in the art will recognize that changes may be made in form and detail without departing from the spirit and scope of the invention.

I claim:

1. A system for introducing a module into a pipeline being fed from a vessel into a body of water, the system comprising:
a tower mounted on the vessel and adapted to feed the pipeline into the body of water;
a rail mounted on the tower; and
a hang-off clamp adapted to support the pipeline and to travel along the rail between a pipeline feeding station and a module insertion station.

2. The system of claim 1 wherein the hang-off clamp travels approximately horizontally between the pipeline feeding station and the module insertion station.

3. The system of claim 1 wherein the tower comprises a J-lay type tower.

4. The system of claim 1 further comprising a by-pass system operable at the module insertion station and adapted to position the module below the hang-off clamp.

5. The system of claim 4 wherein the by-pass system comprises an abandonment and recovery line system.

6. The system of claim 4 further comprising a by-pass station for locating the hang-off clamp while the by-pass system positions the module.

7. A system for introducing a module into a pipeline during deepwater pipeline installation, the system comprising:
(a) a first station;
(b) a second station; and
(c) a hang-off clamp adapted to support the pipeline and translate between the first and second stations.

8. The system of claim 7 wherein the hang-off clamp translates approximately horizontally between the first station and the second station.

9. The system of claim 7 wherein the first station comprises a pipeline feeding station and the second station comprises a module insertion station.

10. The system of claim 9 further comprising a vessel mounted tower adapted to feed the pipeline through the hang-off clamp when the hang-off clamp is positioned at the pipeline feeding station.

11. The system of claim 10 wherein the vessel mounted tower comprises a J-lay type tower.

12. The system of claim 10 further comprising rails for supporting the hang-off clamp for translation between the pipeline feeding and module insertion stations.

13. The system of claim 10 further comprising a by-pass system operable at the module insertion station and adapted to lower the module below the hang-off clamp.

14. The system of claim 13 wherein the by-pass system comprises an abandonment and recovery line system.

15. The system of claim 13 further comprising a by-pass station for placing the hang-off clamp while the by-pass system lowers the module.

16. A method for introducing a module into a pipeline during deepwater pipeline installation, comprising supporting the pipeline by a hang-off clamp adapted to translate between a first station and a second station.

17. The method of claim 16 further comprising translating the hang-off clamp and pipeline between the first station to the second station.

18. The method of claim 17 wherein the first station comprises a pipeline feeding station and the second station comprises a module insertion station.

19. The method of claim 18 further comprising, prior to translating the hang-off clamp and pipeline, severing the pipeline to form a stored pipeline and a suspended pipeline, the suspended pipeline being the pipeline that is translated by the hang-off clamp from the pipeline feeding station to the module insertion station.

20. The method of claim 19 further comprising connecting the module to an upper end of the suspended pipeline.

21. The method of claim 20 further comprising:
(a) transferring support of the suspended pipeline and connected module from the hang-off clamp to a by-pass system;
(b) releasing the suspended pipeline from the hang-off clamp; and
(c) lowering the suspended pipeline and module to a position where the module is below the hang-off clamp.

22. The method of claim 21 further comprising transferring support of the suspended pipeline and module from the by-pass system back to the hang-off clamp.

23. The method of claim 22 further comprising translating the hang-off clamp and suspended pipeline back to the pipeline feeding station.

24. A method for introducing a module into a pipeline being fed down through a pipe tensioner of a vessel mounted tower and into a body of water, the method comprising:
(a) engaging the pipeline with a hang-off clamp below the pipe tensioner;
(b) forming the pipeline into two sections by severing the pipeline at a module insertion location on the pipeline between the pipe tensioner and the hang-off clamp;
(c) displacing one of the pipeline sections relative to the other without disengaging the hang-off clamp from the pipeline.

25. The method of claim 24 wherein the displacement of one of the pipeline sections relative to the other is generally horizontal.

26. The method of claim 25 wherein the two pipeline sections comprise an upper pipeline engaged by the pipe tensioner and a lower pipeline engaged by the hang-off clamp.

27. The method of claim 26 further comprising connecting the module to an upper end of the lower pipeline.

28. The method of claim 27 further comprising lowering the module below the hang-off clamp with a by-pass system.

29. The method of claim 28 further comprising realigning the upper and lower pipelines with each other and connecting the module to the upper pipeline.
